(19) United States
(12) Patent Application Publication
(10) Pub. No.: US 2007/0203772 A1
(43) Pub. Date: Aug. 30, 2007

(54) Method and system for assigning responsibility for developing a compensation plan

(76) Inventors: Eugene Eun, Berkeley, CA (US); Brian Christopher Rowles, Acton, MA (US)

Correspondence Address: CSA LLP, 4807 SPICEWOOD SPRINGS RD., BLDG. 4, SUITE 201, AUSTIN, TX, 78759, US

(21) Appl. No.: 10/230,954

(22) Filed: Aug. 28, 2002

(51) Int. Cl. G05B 19/418; G06F 15/02; G06F 9/46

(52) U.S. Cl. 705/8; 705/9

(57) ABSTRACT

A method and system for assigning responsibility for developing compensation plans. The compensation system assigns responsibility for developing compensation plans to various managers within the management hierarchy of an organization. Each responsible manager is responsible for developing the compensation plan for their direct reports and for any indirect reports whose managers do not have responsibility for developing a compensation plan. The compensation system allows a manager's responsibility for developing a compensation plan to be reassigned to the next higher level manager and to be subsequently reassigned back down to the lower level manager.

### TECHNICAL FIELD

The described technology relates generally to techniques in a computer system for assigning responsibility to managers for developing a compensation plan.

### BACKGROUND

The development of compensation plans for large organizations has traditionally been done manually in a way that is very time-consuming and fraught with inconsistencies. Typically, an organization, such as a large company, has a management hierarchy (also referred to as an organization chart or position hierarchy) with a president or chief executive officer at the top or first level of the management hierarchy. The direct reports of the president are second level managers, the direct reports of the second level manager are third level managers, and so on. The lowest level managers typically have non-managers as their direct reports. Generally, each manager is responsible for developing a compensation plan for their direct reports. A compensation plan may indicate a new salary, a bonus, new stock option grants, and so on for each direct report of the manager. To develop a compensation plan, a manager would typically gather job performance and salary information about each direct report. The process of collecting and analyzing this information can be time-consuming and error prone. In addition, the development of a compensation plan can be delayed by a manager's absence, such as when a manager is on a sabbatical. The delay in the development of the compensation plan of one manager may result in a delay of finalizing the compensation plans for the entire organization. When completed, the compensation plan may then be sent by the manager to the manager's own manager and so on up the management hierarchy until final approval is obtained. During the approval process, a manager may decide that the compensation plan of a lower level manager is inconsistent with the organization goals or other compensation plans. In such case, that manager may direct the lower level manager to revise their compensation plan accordingly.

To help reduce the time it takes to develop compensation plans and to improve consistency, systems have been developed to help automate or otherwise computerize the development of compensation plans. Such systems may provide each manager with easy access to salary and job performance information about their direct reports. In addition, the systems may provide guidelines to each manager to help ensure that their compensation plan is consistent with the organization goals and the compensation plans developed by other managers. The systems may then allow for the automatic routing of the compensation plans as part of the approval process. The systems may also allow detailed and summary reports to be generated at various management levels. These systems help speed up compensation planning, provide managers with easy access to relevant information, and help ensure that the compensation plans meet the goals of the organization.

It would be desirable to have a compensation system that would provide more flexibility in assigning responsibility for developing compensation plans so that the compensation plan for the direct reports of the manager can be developed in the manager's absence, can be assigned to managers who can help ensure consistency, and so on.

### BRIEF DESCRIPTION OF THE DRAWINGS

FIG. 1 is a block diagram illustrating a management hierarchy of an example organization.

FIG. 2 illustrates a display page used by an administrator to create compensation plans in one embodiment.

FIG. 3 illustrates a display page used by a manager to develop a compensation plan in one embodiment.

FIG. 4 illustrates a display page in which the compensation plan of a direct report has been rolled up in one embodiment.

FIG. 5 illustrates a display page in which the reports covered by a rolled up compensation plan are listed in one embodiment.

FIG. 6 is a block diagram illustrating components of the compensation system in one embodiment.

FIG. 7 is a flow diagram illustrating the process of rolling up a compensation plan in one embodiment.

FIG. 8 is a flow diagram illustrating the process of generating a compensation plan display for a manager in one embodiment.

### DETAILED DESCRIPTION

A method and system for assigning responsibility for developing compensation plans is provided. In one embodiment, the compensation system assigns responsibility for developing compensation plans to various managers within the management hierarchy of an organization. Each responsible manager is responsible for developing the compensation plan for their direct reports and for any indirect reports whose managers do not have responsibility for developing a compensation plan. The compensation system allows a manager's responsibility for developing a compensation plan to be reassigned to the next higher level manager. That higher level manager would then be responsible for developing the compensation plan for their own direct reports and the compensation plan of the lower level manager, which may include both direct and indirect reports of that lower level manager. The process of reassigning responsibility for developing a compensation plan to the next higher level manager is referred to as “rolling up” the compensation plan. When a compensation plan is rolled up, the manager who previously was assigned the responsibility is relieved of the responsibility for developing that compensation plan. When the higher level manager completes development of the compensation plan, that higher level manager may forward the compensation plan for final approval. A manager who is responsible for developing a compensation plan that has been rolled up may reassign the responsibility of developing that compensation plan back to the lower level manager. The higher level manager may, for example, roll up a compensation plan, develop a proposed compensation plan, and allow the originally assigned manager to complete development of the compensation plan. The process of reassigning a compensation plan to the next lower level manager is referred to as “rolling down” a compensation plan. In this way, a manager can take over responsibility for developing a compensation plan previously assigned to one of their direct reports and can delegate responsibility for developing a compensation plan for indirect reports to a lower level manager of those reports. The compensation system may also allow a manager to roll up or roll down at the same time the compensation plan of a report along with all the compensation plans of that report's direct and indirect reports.

In one embodiment, the compensation system also allows the initial assignment of responsibilities for developing compensation plans to be set at any management level within the management hierarchy. For example, a compensation plan administrator when initially specifying parameters (e.g., budgeted increases) of various compensation plans may specify the lowest management level, referred to as the “roll out” level, that is responsible for developing compensation plans. Each manager at the specified management level would be responsible for developing a compensation plan for all their reports, direct or indirect. Each manager at a management level lower than the roll out level would initially have no responsibility for developing compensation plans, and each manager at a management level higher than the roll out level would initially have responsibility for developing the compensation plan only for their direct reports. The compensation system may also allow an administrator to specify different management levels for different groups within an organization. For example, the administrator may specify that the responsibility for developing compensation plans for a program development group is at the third level of management and may specify that the responsibility for developing compensation plans for a finance group is at the second level of management. By allowing the specification of the responsible management level, the compensation system allows administrators to quickly and flexibly assign primary responsibility for developing compensation plans to any management level. In addition, the managers assigned responsibility for developing compensation plans may roll up and roll down compensation plans as appropriate.

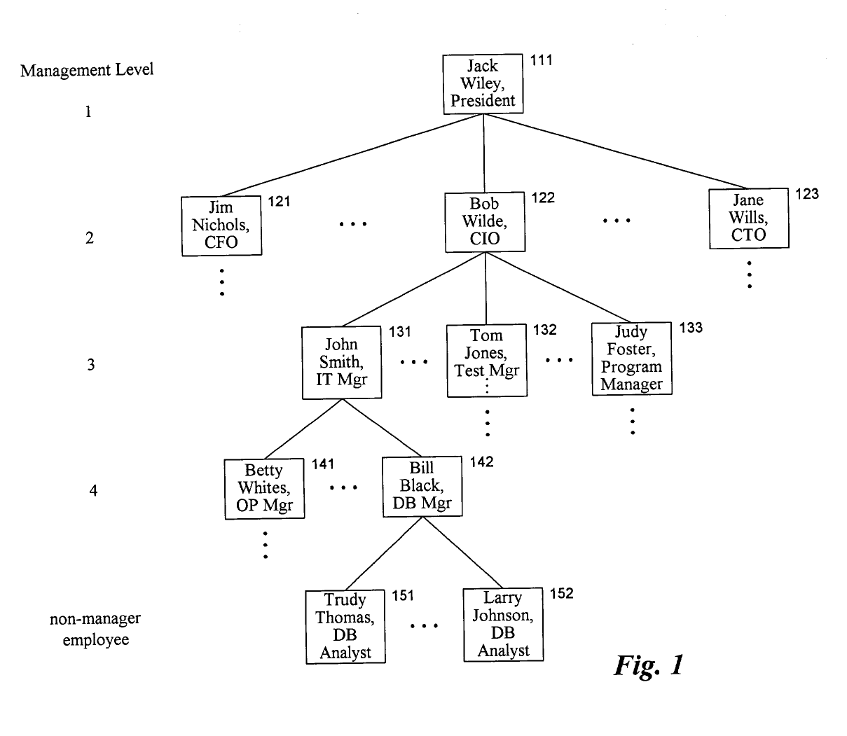

FIG. 1 is a block diagram illustrating a management hierarchy of an example organization. The organization has four management levels. Jack Wiley, the president, is at the first management level as indicated by block 111. The direct reports of the president are the managers at the second management level including Jim Nichols, chief financial officer, as indicated by block 121; Bob Wilde, chief information officer, as indicated by block 122; and Jane Wills, chief technology officer, as indicated by block 123. The horizontal ellipses between the blocks indicate that there are other managers at that level that are not shown, and the vertical ellipses indicate that there are direct reports that are not shown. In this example, the chief information officer has direct reports that include John Smith, information technology manager, as indicated by block 131; Tom Jones, test manager, as indicated by block 132; and Judy Foster, program manager, as indicated by block 133. The information technology manager has direct reports that include the Betty White, operations manager, as indicated by block 141 and Bill Black, database manager, as indicated by block 142. The non-manager direct reports of the database manager include Trudy Thomas as indicated by block 151 and Larry Johnson as indicated by block 152. One skilled in the art will appreciate that different groups with the management hierarchy may have differing numbers of management levels. For example, the management of the chief information officer's group may extend down to the fourth management level, and the management of the chief financial officer's group may extend only down to the third management level. In this example, John Smith, Tom Jones, and Judy Foster are direct reports of Bob Wilde, and Betty White, Bill Black, Trudy Thomas, and Larry Johnson are indirect reports of Bob Wilde.

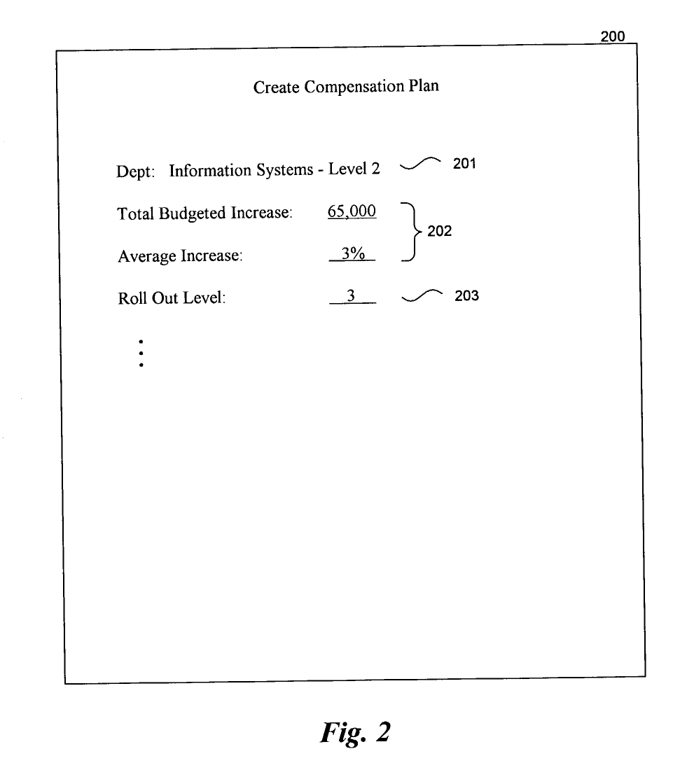

FIG. 2 illustrates a display page used by an administrator to create compensation plans in one embodiment. A compensation plan may be created for each manager at or above the roll out level. The display page 200 includes the name of the group of the organization for which the compensation plans are being created 201, budgeting information 202 for that group, and the roll out level 203 for that group. In this example, the compensation plan is being developed for the information systems group which is headed by a manager at level two of the management hierarchy. The budgeting information includes the total budgeted increase for the group and the average percentage increase for the group. The roll out level specifies the management level that is to be assigned responsibility for developing the compensation plans for all lower levels. In this example, the roll out level is management level 3. Referring to FIG. 1, since the roll out level is 3, the managers John Smith, Tom Jones, and Judy Foster will have responsibility for developing the compensation plans for their direct and indirect reports. The managers at levels higher than level 3 (i.e., levels 1 and 2) will have responsibility for developing the compensation plan for their direct reports.

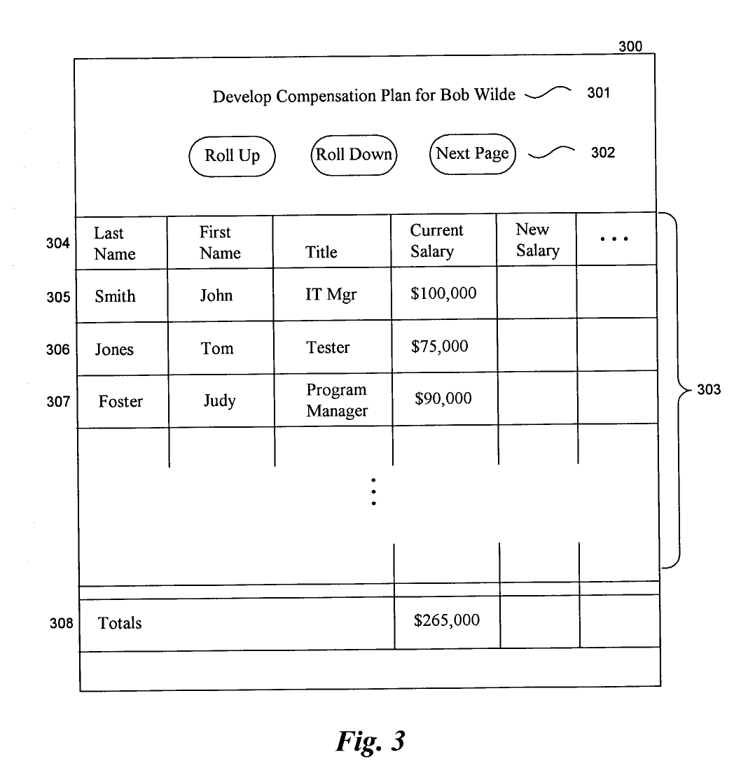

FIG. 3 illustrates a display page used by a manager to develop a compensation plan in one embodiment. The display page 300 includes manager identification area 301, buttons 302, planning area 303, and totals area 308. The manager identification area identifies that the compensation plan assigned to Bob Wilde is being developed. The planning area includes a title line 304 and information lines 305-307 for each report that is included in a compensation plan that the manager is responsible for developing. Each information line includes the name, title, current salary, new salary, and so on for each of those reports. The manager enters the new salary information for each of the reports and may select the next page button to continue the development of the compensation plan. The totals area contains the salary totals for the reports. The roll up and roll down buttons are used to roll up and roll down a compensation plan. To roll up a compensation plan, the manager selects a report and then selects the roll up button. Although not shown, roll up all and roll down all buttons may also be available to indicate that the compensation plan of a selected report and all the compensation plans of the direct and indirect reports of that selected report are also to be rolled up or down.

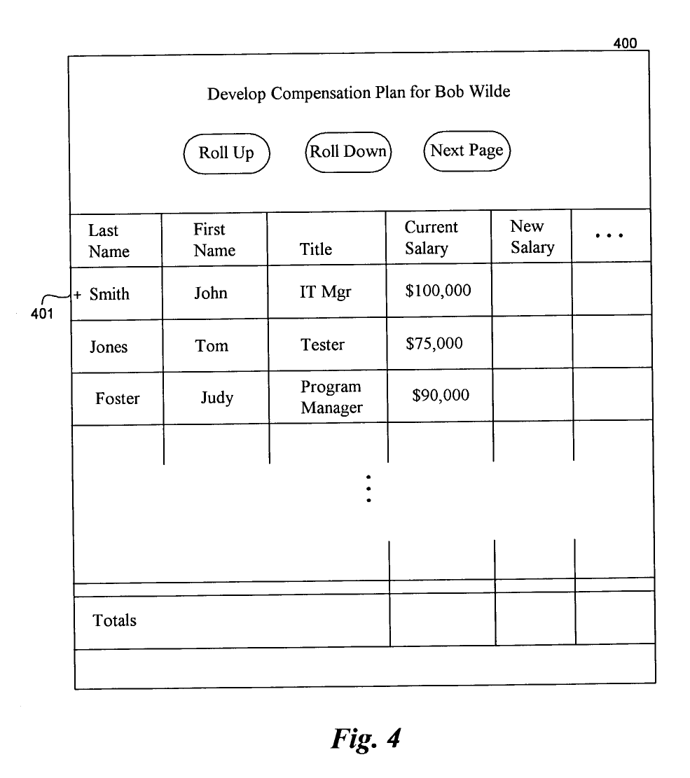

FIG. 4 illustrates a display page in which the compensation plan of a direct report has been rolled up in one embodiment. In this example, the manager decided to roll up the compensation plan of John Smith. The roll up is indicated by the plus sign 401 to the left of the information line for John Smith. The manager can select the plus sign to display the direct reports of John Smith who are covered by the compensation plan that has now been assigned to Bob Wilde. Alternatively, rather that nesting the reports covered by a rolled up compensation plan, the reports can simply be listed following the last report without any nesting.

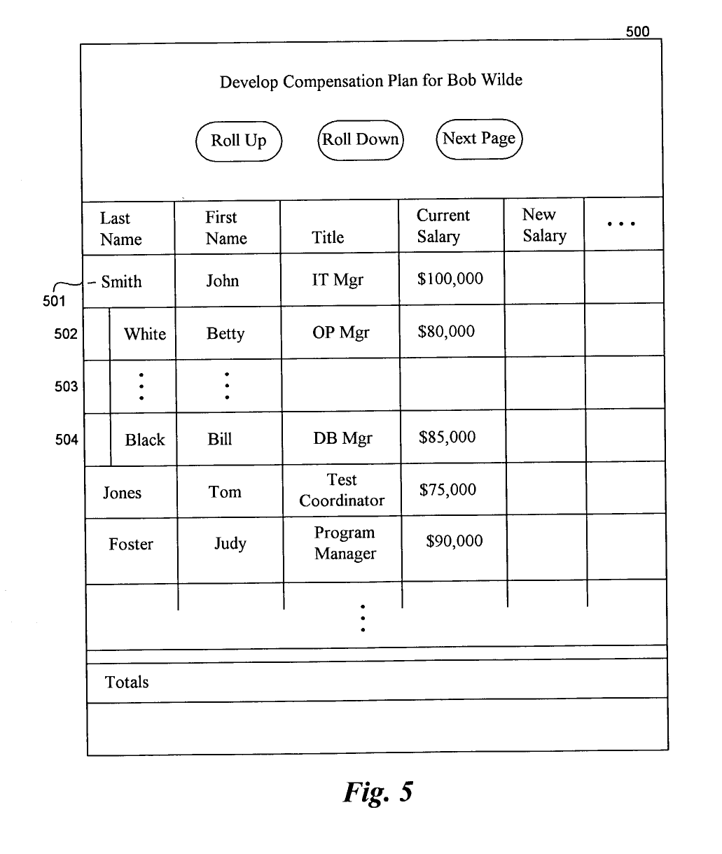

FIG. 5 illustrates a display page in which the reports covered by a rolled up compensation plan are listed in one embodiment. The manager selected the plus sign to the left of the information line for John Smith in FIG. 4 to list these reports. In response, the compensation system replaced the plus sign with a minus sign 501 and listed each of the direct reports of John Smith on a separate information line 502-504 in association with the information line of John Smith. With the direct reports of John Smith listed, the manager can view the salary information and enter new salary information for each of the direct reports of John Smith. The manager can use the plus and minus to toggle between listing and not listing the reports covered by the compensation plan that has been rolled up. To roll down a compensation plan, the manager selects the information line for John Smith and then selects the roll down button. One skilled in the art will appreciate that the rolling up and down of compensation plans can be nested to any level. For example, the manager Bob Wilde could select the information line for a Betty White and request that the compensation plan that she is responsible for developing be rolled up two levels and be assigned to Bob Wilde. In one embodiment, the compensation system allows a compensation plan to be rolled down to a level only if it has previously been rolled up from that level.

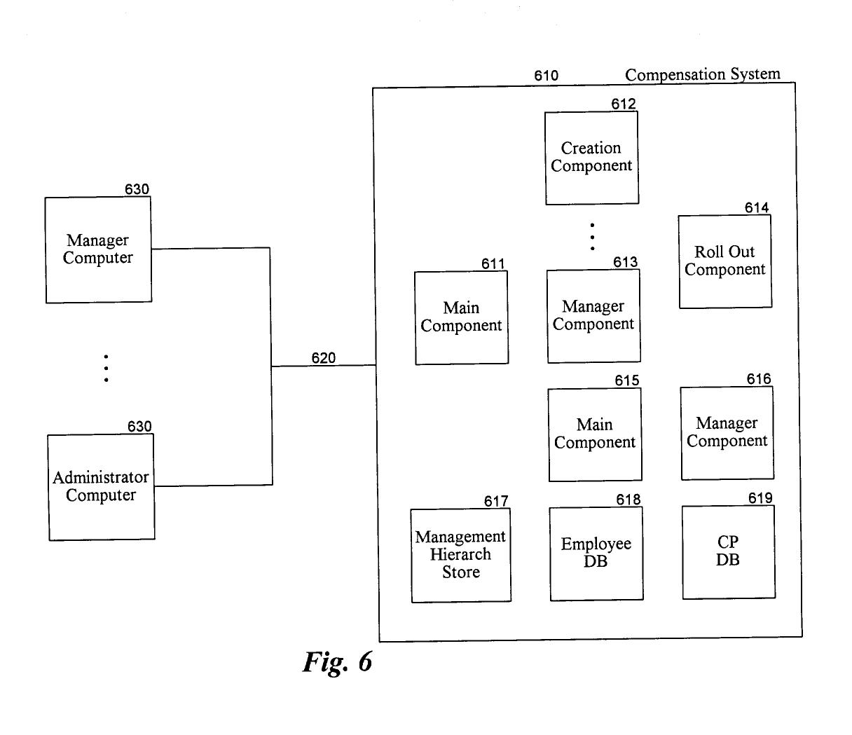

FIG. 6 is a block diagram illustrating components of the compensation system in one embodiment. The compensation system may be implemented on a application server 610 that is connected to manager and administrator computers 630 via a communications link 620. The compensation system may include a main component 611, an administrator component 612, a manager component 613, a roll out component 614, a roll up component 615, a roll down component 616, a management hierarchy store 617, an employee database 618, and a compensation planning database 619. The main component provides the primary interface through which a user can select the administrator or manager functions of the compensation system. The administrator component allows an administrator to create compensation plans and, using the roll out component, to assign the responsibility for developing the compensation plans to a certain management level. The administrator component may generate the display page of FIG. 2. The manager component allows a manager to develop the compensation plan and to roll up and roll down compensation plans using the roll up and roll down components. The manager component may generate the display pages of FIGS. 3-5. The management hierarchy store may contain information that describes the management hierarchy of an organization. This information may be stored in a separate store as shown or may be integrated with the employee database. The employee database contains information relating to each employee such as their current job title, salary, and salary plan. The compensation planning database may contain a compensation plan for each manager. The compensation plan for a manager may indicate the direct reports covered by the compensation plan and may indicate any compensation plans that have been rolled up from lower level managers or may indicate that the manager's compensation plan has been rolled up to a higher level manager.

One skilled in the art will appreciate that these components and data stores illustrate the possible organization of functions and data of the compensation system. The actual division of the functions into programs, subroutines, modules, and so on and the data structures and data organizations may be different. For example, the databases can be any type of appropriate data store.

The computers may include a central processing unit, memory, input devices (e.g., keyboard and pointing devices), output devices (e.g., display devices), and storage devices (e.g., disk drives). The memory and storage devices are computer-readable media that may contain instructions that implement the compensation system. In addition, the data structures and message structures may be stored or transmitted via a data transmission medium, such as a signal on a communications link. Various communications links may be used, such as the Internet, a local area network, a wide area network, or a point-to-point dial-up connection.

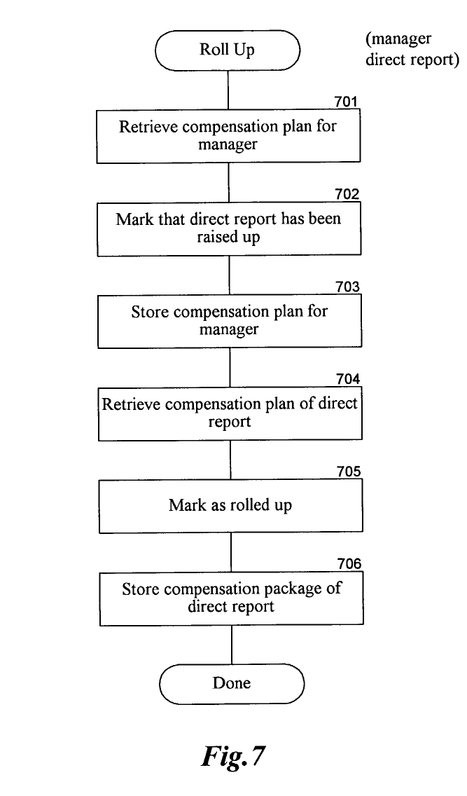

FIG. 7 is a flow diagram illustrating the process of rolling up a compensation plan in one embodiment. This component is passed an indication of a manager and a direct report whose compensation plan is to be rolled up to the manager. In block 701, the component retrieves the compensation plan for the manager from the compensation planning database. In block 702, the component marks the direct report in the retrieved compensation plan as having their compensation plan rolled up into the manager. In block 703, the component stores the updated compensation plan for the manager in the compensation planning database. In block 704, the component retrieves the compensation plan of the direct report from the compensation planning database. In block 705, the component marks the retrieved compensation plan as having been rolled up into the compensation plan of the manager. In block 706, the component stores the updated compensation plan of the direct report in the compensation planning database and then completes. One skilled in the art will appreciate that this component can be invoked multiple times to effect the rolling up of the compensation plans of each direct report, can be modified to receive a list of direct reports whose compensation plan is to be rolled up, and so on. This component may also be modified to roll up the compensation plans of any managers who report, directly or indirectly, to the manager whose compensation plan is being rolled up.

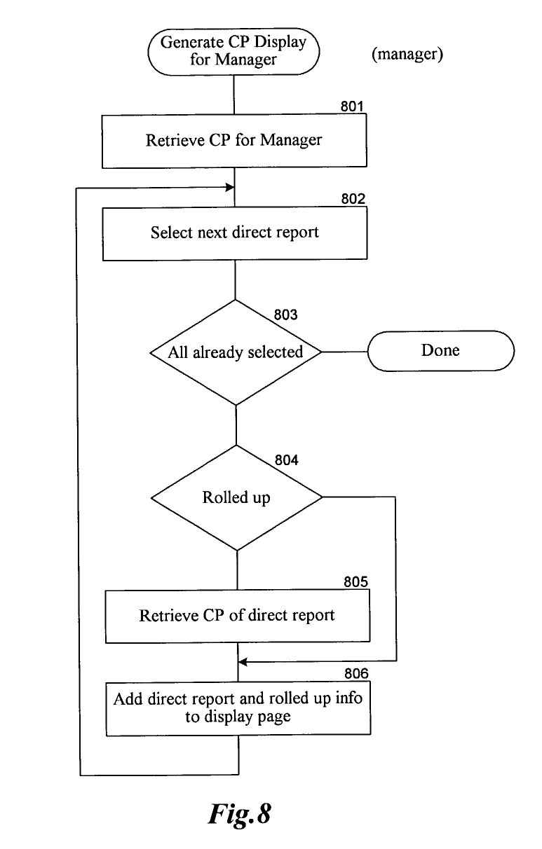

FIG. 8 is a flow diagram illustrating the process of generating a compensation plan display for a manager in one embodiment. This component is passed an indication of the manager and returns a display page for that manager. In block 801, the component retrieves the compensation plan for the manager from the compensation planning database. In blocks 802-806, the component loops processing each direct report of the manager and adding their information to the display page. In block 802, the component selects the next direct report of the manager as indicated by the compensation plan. In decision block 803, if all direct reports of the manager have already been selected, then the component completes by returning the display page, else the component continues at block 804. In decision block 804, if the compensation plan of the selected direct report has been rolled up, then the component continues at block 805, else the component continues at block 806. In block 805, the component retrieves the compensation plan of the selected direct report from the compensation planning database. In block 806, the component adds an information line for the selected direct report to the display page and information lines for any rolled up compensation plan for the selected direct report. The component then loops to block 802 to select the next direct report. One skilled in the art will appreciate that the component may generate a display for compensation plans that have been rolled up through multiple levels.

From the foregoing it will be appreciated that although specific embodiments of the technology have been described herein for purposes of illustration, various modifications may be made without deviating from the spirit and scope of the invention. Accordingly, the invention is not limited except by the appended claims.

I/We claim:

1. A method in a computer system for assigning responsibility for developing a compensation plan, comprising:
receiving from a higher level manager a request to reassign responsibility for developing a compensation plan for direct reports of a lower level manager; and
in response to receiving the request, reassigning the responsibility for developing the compensation plan in accordance with the received request.

2. The method claim 1 wherein the request indicates to reassign responsibility to the higher level manager.

3. The method of claim 1 wherein the request indicates to reassign responsibility to the lower level manager.

4. The claim 3 wherein the responsibility is reassigned to the lower level manager only if responsibility was previously reassigned from the lower level manger to the higher level manager.

5. A method in a computer system for assigning responsibility for developing a compensation plan, the method comprising:
assigning to a first manager responsibility for developing a compensation plan for direct reports of the first manager;
receiving from a second manager who is a manager of the first manager an indication to reassign the responsibility for developing the compensation plan for the direct reports of the first manager to the second manager; and
reassigning to the second manager responsibility for developing the compensation plan for the direct reports of the first manager
so that the second manager has responsibility for developing the compensation plan for the direct reports of the second manager and for the direct reports of the first manager.

6. The method of claim 5 including:
providing a definition of a management hierarchy, the management hierarchy identifying direct reports of each manager; and
determining the direct reports of the first manager and determining the manager of the first manager based on the management hierarchy.

7. The method of claim 5 including:
displaying to the second manager identifications of the direct reports of the second manager, the identifications including an identification of the first manager; and
displaying to the second manager and in association with the displayed identification of the first manager identifications of direct reports of the first manager.

8. The method of claim 7 wherein the displaying of the identifications of the direct reports of the first manager is performed in response to receiving a request from the second manager.

9. The method of claim 5 wherein the second manager develops the compensation plan for the direct reports of the first manager and including providing an indication that the compensation plan for the direct reports of the first manager has been developed.

10. The method of claim 5 including:
after reassigning to the second manager,
receiving from the second manager an indication to reassign the responsibility for developing the compensation plan for the direct reports of the first manager back to the first manager; and
reassigning back to the first manager responsibility for developing the compensation plan for the direct reports of the first manager.

11. The method of claim 10 wherein, before reassigning back to the first manager, the second manager develops a proposed compensation plan for the direct reports of the first manager.

12. The method of claim 11 wherein, after reassigning back to the first manager, the first manager completes the development of the compensation plan for the direct reports of the first manager based on the proposed compensation plan.

13. The method of claim 5 wherein the assigning to the first manager the responsibility for developing a compensation plan for direct reports of the first manager is performed by specifying a level of management that is to have responsibility for developing compensation plans and the first manager is at that level of management.

14. A method in a computer system for assigning responsibility for developing a compensation plan, the method comprising:
assigning to a second manager responsibility for developing a compensation plan for direct reports of a first manager, the first manager being a direct report of the second manager;
receiving from the second manager an indication to reassign the responsibility for developing the compensation plan for the direct reports of the first manager to the first manager; and
reassigning to the first manager responsibility for developing the compensation plan for the direct reports of the first manager.

15. The method of claim 14 including:
providing a definition of a management hierarchy that identifies direct reports of managers; and
determining the direct reports of the first and second managers based on the management hierarchy.

16. The method of claim 14 including:
before reassigning the responsibility to the first manager,
displaying to the second manager identifications of the direct reports of the second manager, the identifications including an identification of the first manager; and
displaying to the second manager and in association with the displayed identification of the first manager identifications of direct reports of the first manager.

17. The method of claim 16 wherein the displaying of the identifications of the direct reports of the first manager is performed in response to receiving a request from the second manager.

18. The method of claim 14 wherein the first manager develops the compensation plan for the direct reports of the first manager and including providing an indication that the compensation plan for the direct reports of the first manager has been developed.

19. The method of claim 14 including:
after reassigning to the first manager,
receiving from the second manager an indication to reassign the responsibility for developing the compensation plan for the direct reports of the first manager back to the second manager; and
reassigning back to the second manager responsibility for developing the compensation plan for the direct reports of the first manager.

20. The method of claim 19 wherein, before reassigning back to the second manager, the first manager develops a proposed compensation plan for the direct reports of the first manager.

21. The method of claim 20 wherein, after reassigning back to the second manager, the second manager completes the development of the compensation plan for the direct reports of the first manager based on the proposed compensation plan.

22. The method of claim 14 wherein the assigning to the second manager the responsibility for developing a compensation plan for direct reports of the first manager is performed by specifying a level of management that is to have responsibility for developing compensation plans and the second manager is at that level of management.

23. The method of claim 14 wherein the reassigning is performed only if the responsibility for developing a compensation plan was previously reassigned from the first manager to the second manager.

24. A method in a computer system for assigning responsibility for developing a compensation plan, the method comprising:
providing a definition of a management hierarchy having levels of management, each manager in the hierarchy having direct reports;
receiving an indication of a level of management that is to have responsibility for developing a compensation plan; and
assigning to each manager at the indicated level of management as determined from the management hierarchy responsibility to develop a compensation plan for direct reports and any indirect reports of that manager.

25. The method of claim 24 including receiving an indication that a compensation plan has been developed by the manager to which responsibility was assigned.

26. The method of claim 24 wherein the compensation plan is assigned to a first manager and a second manager who is a manager of the first manger requests to be assigned responsibility for developing the compensation plan on behalf of the first manager.

27. The method of claim 26 wherein, after developing a proposed compensation plan, the second manager requests that the responsibility for developing the compensation plan be reassigned back to the first manager.

28. The method of claim 24 wherein the compensation plan is assigned to a second manager and the second manger requests that responsibility for developing the compensation plan be assigned to a first manager who is a direct report of the second manager.

29. The method of claim 28 wherein, after the first manager develops a proposed compensation plan, the responsibility for developing the compensation plan is reassigned back to the second manager.

30. A computer system for assigning responsibility for developing compensation plans, comprising:
a data store for storing indications of managers who are currently responsible for developing the compensation plans; and
a component that receives from a higher level manager an indication take over responsibility for developing a compensation plan from a lower level manager who is currently responsible for developing the compensation plan and that updates the data store to indicate that the higher level manager is now responsible for developing the compensation plan.

31. The computer system of claim 30 wherein the lower level manager is a direct report of the higher level manager.

32. The computer system of claim 30 wherein when the lower level manager is not a direct report of the higher level manager and wherein the component updates the data store to indicate that the higher level manager is now responsible for developing a compensation plan for each manger in between the higher level manager and the lower level manager.

33. The computer system of claim 30 including a component that controls displaying to the higher level manager identifications of direct reports of the lower level manager.

34. The computer system of claim 33 wherein the identifications of the direct reports of the lower level manager are displayed as nested within an identification of the lower level manager.

35. The computer system of claim 33 wherein the identifications of the direct reports of the lower level manager are listed after the identifications of the direct reports of the higher level manager.

36. The computer system of claim 33 including a component that receives from a higher level manager an indication hand back responsibility for developing a compensation plan to the lower level manager and that updates the data store to indicate that the lower level manager is now responsible for developing the compensation plan.

37. A computer system for assigning responsibility for developing compensation plans, comprising:
means for storing indications of managers who are currently responsible for developing the compensation plans; and
means for updating the means for storing to indicate that a higher level manager has taken over responsibility for developing a compensation plan currently assigned to a lower level manager, when requested by the higher level manager.

38. The computer system of claim 37 wherein the lower level manager is a direct report of the higher level manager.

39. The computer system of claim 37 including updating the means for storing to indicate that the higher level manager is now responsible for developing a compensation plan for each manger in between the higher level manager and the lower level manager, when the lower level manager is not a direct report of the higher level manager.

40. The computer system of claim 37 including means for updating the means for storing to indicate that the lower level manager is now responsible for developing the compensation plan, when requested by the higher level manager.

41. A computer-readable medium containing instructions for controlling a computer system to assign responsibility for developing a compensation plan, by a method comprising:
receiving from a higher level manager a request to reassign responsibility for developing a compensation plan for direct reports of a lower level manager; and
in response to receiving the request, reassigning the responsibility for developing the compensation plan in accordance with the received request.

42. The computer-readable medium of claim 41 wherein the request indicates to reassign responsibility to the higher level manager.

43. The computer-readable medium of claim 41 wherein the request indicates to reassign responsibility to the lower level manager.

44. The computer-readable medium of claim 43 wherein the responsibility is reassigned to the lower level manager only if responsibility was previously reassigned from the lower level manger to the higher level manager.

45. A method in a computer system for indicating reassignment of responsibility for developing a compensation plan, the method comprising:
displaying to a manager identifications of reports covered by a compensation plan assigned to that manager;
receiving from the manager a selection of a report;
receiving from the manager an indication to roll up a compensation plan currently assigned to the selected report; and
sending an indication that the compensation plan of the selected report is to be rolled up to the manager.

46. The method of claim 45 wherein the selected direct report was initially assigned responsibility for developing the compensation plan based on a roll out level.

47. The method of claim 45 including:
after sending the indication,
receiving from the manager a selection of the report;
receiving from the manager an indication to roll down the compensation plan back to the selected report; and
sending an indication that the compensation plan is to be rolled down to the selected report.

48. The method of claim 45 wherein the report is a direct report.

49. The method of claim 45 wherein the report is an indirect report.

50. A method in a computer system for assigning compensation plans, the method comprising:
assigning compensation plans to managers;
receiving from a manager an indication to reassign the compensation plan of a direct report and the compensation plans of any reports of that direct report to the manager; and
assigning to the manager the compensation plan of the direct report and the compensation plans of any direct reports of that manager.

51. A method in a computer system for assigning compensation plans, the method comprising:
assigning compensation plans to a manager,
receiving from the manager an indication to reassign a compensation plan to a direct report and to reassign compensation plans to each report of that direct report; and
assigning a compensation plan to the direct report of the manager and compensation plans to any reports of that direct report.

52. A method in a computer system for assigning compensation plans, the method comprising:
assigning to a first manager a compensation plan;
receiving from a second manager an indication to reassign the compensation plan to the second manager; and
reassigning to the second manager the compensation plan.

53. The method of claim 52 including:
after reassigning the compensation plan,
receiving from the second manager an indication to reassign the compensation plan back to the first manager; and
reassigning to the first manager the compensation plan.
